(19) United States
(12) Patent Application Publication
(10) Pub. No.: US 2020/0138162 A1
(43) Pub. Date: May 7, 2020

(54) HAIR FASTENER AND METHOD OF MANUFACTURE THEREOF

(71) Applicant: Tung Hing Plastic Manufactory Ltd., Hong Kong (HK)

(72) Inventor: Ka Chuen SZE, Hong Kong (HK)

(73) Assignee: Tung Hing Plastic Manufactory Ltd., Hong Kong (HK)

(21) Appl. No.: 16/417,686

(22) Filed: May 21, 2019

Related U.S. Application Data
(63) Continuation-in-part of application No. 14/962,076, filed on Dec. 8, 2015, now abandoned.

(51) Int. Cl. A45D 8/34; B32B 38/00

(52) U.S. Cl. CPC A45D 8/34; B32B 25/10; B32B 2274/00; B32B 38/0004

(57) ABSTRACT

The present invention is concerned with a hair fastener. The hair fastener has a circumferential length from 65-205 mm. The hair fastener is made of an elastic band, a layer of fabric, a first coupler for providing a first connection connecting the opposite ends of said elongate band together, and a second coupler resembling a shell molded over and enveloping the first connection.

### CROSS REFERENCE TO RELATED APPLICATIONS

This application is a Continuation-in-part application from U.S. patent application Ser. No. 14/962,076 which claims priority from earlier filed GB Patent Application No. 1501421.0 filed Jan. 28, 2015, contents of both the Continuation-in-part application and the GB application in their entirety are incorporated herein.

### FIELD OF THE INVENTION

The present invention is concerned with a hair fastener and in particular a type of hair fasteners in the form of an elastic loop and a method of manufacture thereof.

### BACKGROUND OF THE INVENTION

There is a variety of hair fasteners. One historical hair fasteners is in the form of an elastic band integrally formed into an elastic loop. However, this type of fasteners is disadvantageous because due to the material used hair tends to get tangled with the loop and cause damage to hair. Removal of such hair fasteners after use is thus challenging. An improvement has existed to provide a layer of fabric over the elastic loop before closing the loop. However, such improved hair fasteners, among other disadvantages, tend to break easily at where the loop closes.

The present invention seeks to address these problems, or at least to provide an alternative to the public.

### SUMMARY OF THE INVENTION

According to a first aspect of the present invention, there is provided a hair fastener with a circumferential length from 65-205 mm, comprising:
an elastic band with a width from 0.8-10 mm, defining an outwardly facing surface along a length of the elongate band and with opposite ends defining end surfaces positioned adjacent each other at a connection region thus forming a closed loop;
a layer of fabric enveloping along the length of the elastic band and with opposite ends at the connection region;
a first coupler for providing a first connection connecting the opposite ends of said elongate band together; and
a second coupler resembling a shell molded over and enveloping the first connection thus simultaneously i) providing a second connection to the opposite ends of the elongate band, ii) providing protection of the first coupler by enveloping the first coupler, iii) providing connection to the opposite ends of the fabric layer and iv) enveloping the opposite ends of the fabric layer;
   wherein:
      the first coupler connects the opposite ends of the elastic band together by joining at the end surfaces at the connection region but without increasing width or diameter of the connection region; and
      the second coupler at the connection region is sized and shaped with an enlarged width or diameter compared to the width or diameter of the first coupler at the connection region, wherein the thickness of the shell of the second coupler is from 1-4 mm.

Preferably, the elastic band may have a circular cross section with a width or diameter from 1.8-8.0 mm. Alternatively, the elastic band may have a quadrilateral cross section. Studies leading to the present invention has shown that when the elastic band has a circular cross section, the width or diameter may be reduced to deliver the desired characteristic; and when the elastic band has a quadrilateral cross section the connection is stronger and can providing an improved hair gipping effect.

Advantageously, the elastic band may be made from a material selected from the group consisting of natural rubber, silicone thermoplastic elastomer (TPE) and polyester-polyurethane copolymer elastane.

Suitably, the first coupler may be in the form of a glue selected from a cyanoacrylate family.

In an embodiment, the fabric may be made of nylon, polyester, polypropylene or a combination thereof, and knitted or otherwise formed over said elastic band.

In one embodiment, the elastic band equipped with the first and second couplers may have a pull strength of at least 4 Kg. In a further embodiment, the elastic band equipped with said first and second couplers may has a pull strength of 4-15 Kg. In yet a further embodiment, the elastic band at the first and second connectors may have a pull strength of 10-15 Kg.

The fastener may be free of clip, crimp or clamp for connecting the opposite ends of said elastic band together.

The second coupler may be free of silicon rubber, rubber or polyvinyl chloride (PVC).

Preferably, surface of said coupler may be configured with an anti-slipping characteristics for enhancing grip of surrounding hair.

According to a second aspect of the present invention, there is provided a method of manufacture of a hair fastener described above.

According to a third aspect of the present invention, there is provided a method of manufacture of a hair fastener, comprising steps of:
providing an elongate elastic band with an extended length and with a width or diameter from 0.8-10 mm;
forming a jacket made of a fabric along essentially an entire length over the elastic band;
cutting the elastic band covered with the jacket into sections, each section with a desired length from 65-205 mm, thus producing a plurality of fabric-covered elastic band sections with opposite ends;
providing a primary connection by connecting the opposite ends of each elastic band section with a first coupler such that each elastic band section becomes a closed loop;
optionally completing formation of the fabric jacket over an entire length the loop; and
providing a second coupler fixedly molded over and enveloping the connected opposite ends and the first coupler, thus simultaneously providing secondary connection to the opposite ends of the elastic band, protecting the primary connection and connecting of opposite ends of the fabric jacket, the second coupler resembling a shell and with a thickness of 1-4 mm;
wherein the first coupler is an adhesive for gluing the opposite ends of each said elastic band section together at end surfaces thereof but without increasing circumferential width or diameter of the elastic band section at the opposite ends.

Preferably, the elastic band may be made of natural rubber, silicone, TPE, or polyester-polyurethane copolymer elastane.

Suitably, the jacket may be made of a nylon, polyester, polypropylene or a combination thereof, knitted or otherwise formed over said elastic band.

The adhesive for connecting the opposite ends of the elongate plastic ends may be selected from a cyanoacrylate family.

Preferably, the second connector may be made of thermoplastic elastomer (TPE) and is free of silicon rubber, rubber or polyvinyl chloride (PVC).

The elastic band at the first and second connectors may have a pull strength of at least 4 Kg, preferably 4-15 Kg, and more preferably 0-15 Kg.

### BRIEF DESCRIPTION OF DRAWINGS

Some embodiments of the present invention will now be explained, with reference to the accompanied drawings, in which:

FIG. 1 is a schematic drawing showing a user wearing a conventional hair fastener;

FIG. 2 is a perspective view showing the hair fastener of FIG. 1;

FIG. 3 is a perspective view of the hair fastener of FIG. 2;

FIG. 4 is a schematic view showing an elongate elastic member with a layer of fabric being knitted over a hair fastener of an embodiment of a hair fastener in accordance with the present invention;

FIGS. 5, 6a, 6b and 6c are schematic views showing steps involved in closing of the elastic member of the fastener of FIG. 4;

FIG. 7 is a schematic illustration showing encasing of a connecting region of the fastener from FIG. 6c;

FIGS. 8, 9 and 10 are perspective and side views of the fasteners from FIG. 7 after processing; and

FIG. 11 is a schematic view showing the fastener of FIG. 10 worn by a user.

### PREFERRED EMBODIMENTS OF THE INVENTION

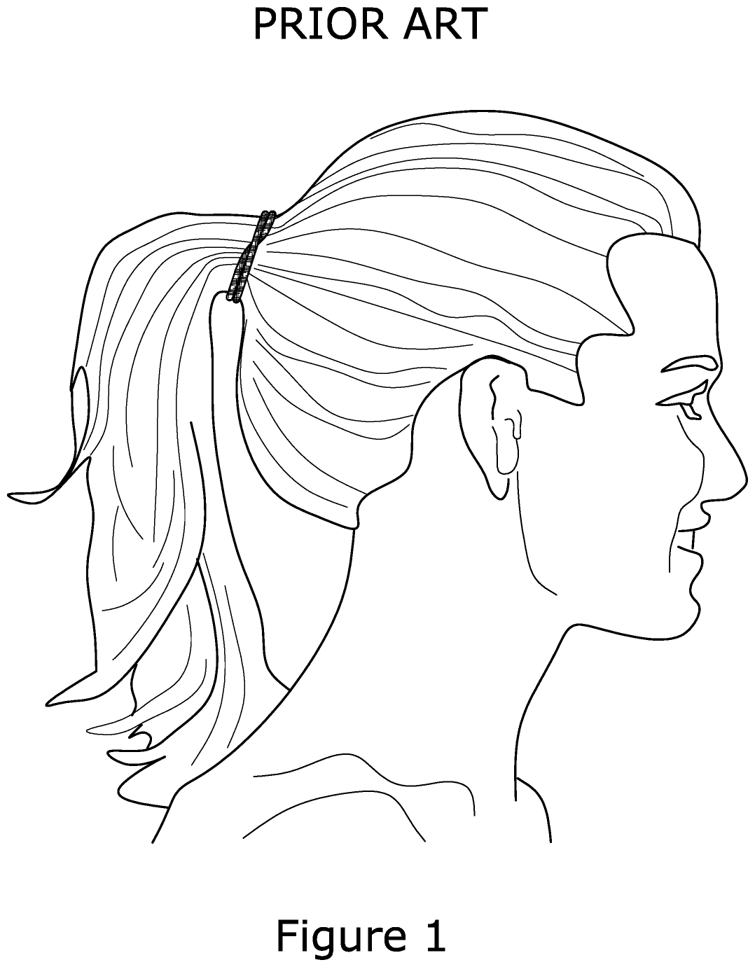

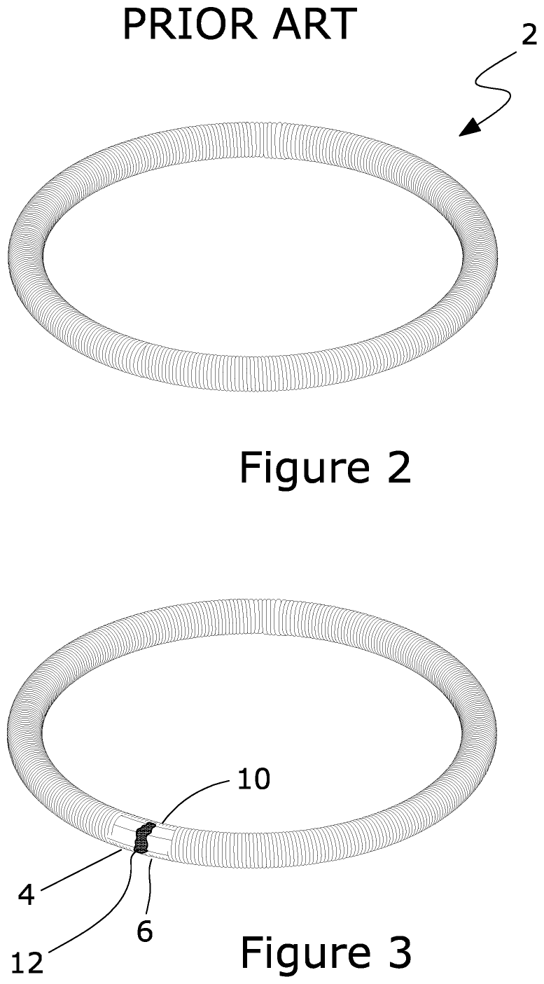

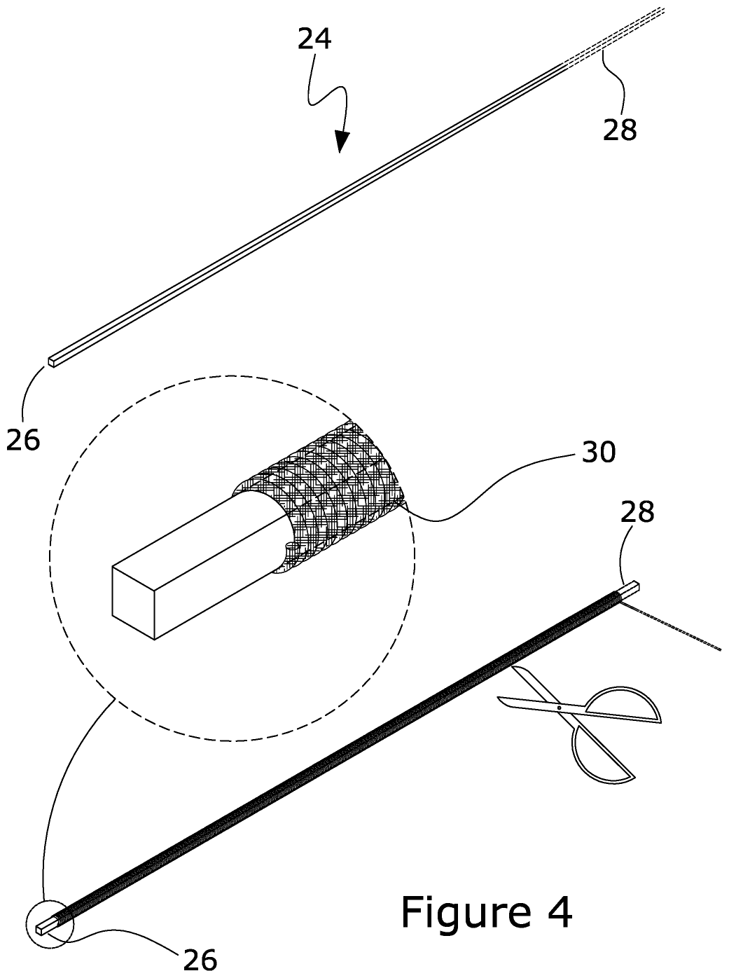

FIGS. 1 to 3 show a prior art hair fastener 2. Such fasteners are typically formed by providing an elongate elastic member with opposite ends 6, 8. A layer of fabric 10 is provided to cover the elastic member. The opposite ends are connected together by a metal crimp 12 on top of the layer of fabric. While the metal crimp 12 connect the opposite ends, on repeated stretching the metal crimp 12 actually cut open the opposite ends thus breaking the connection.

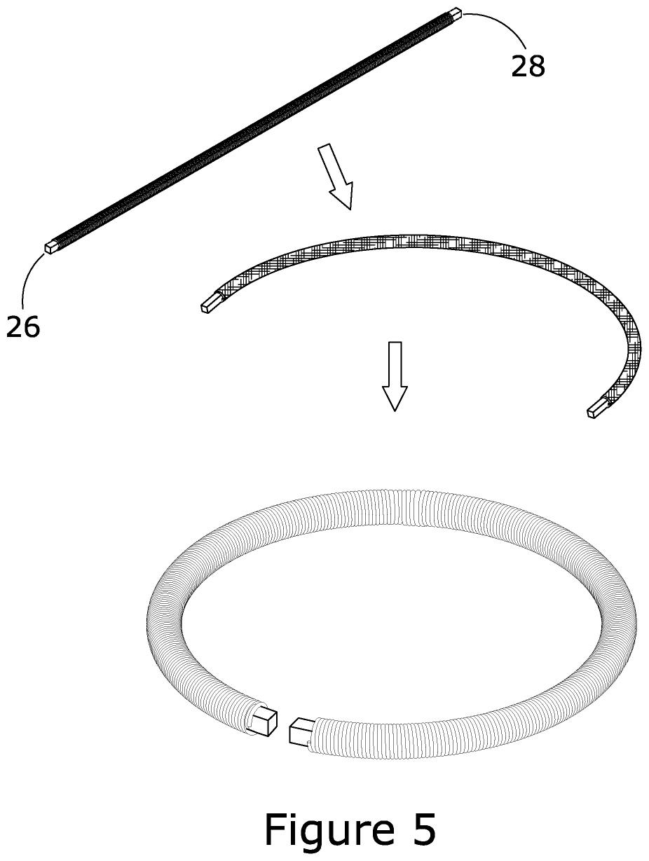

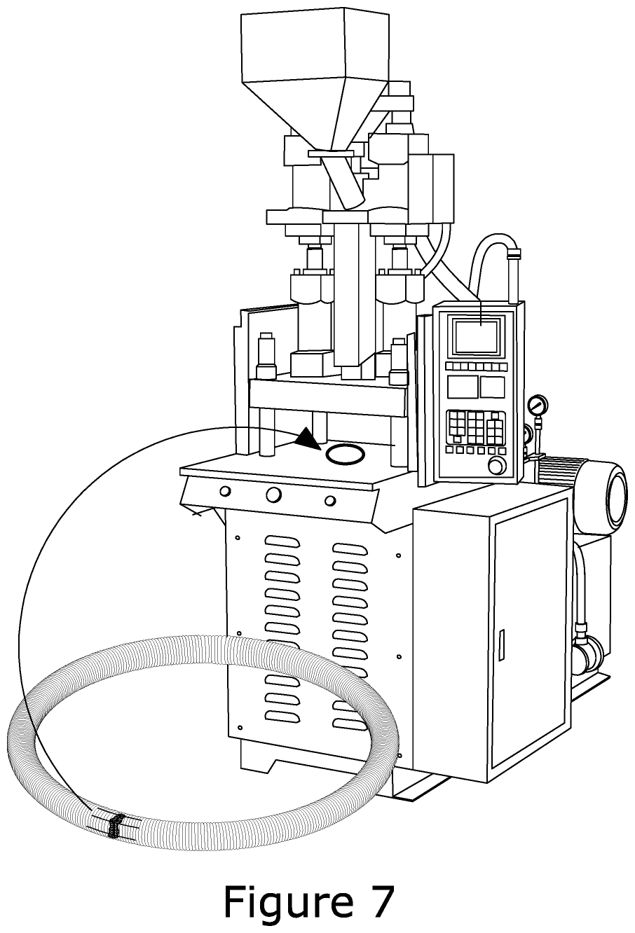

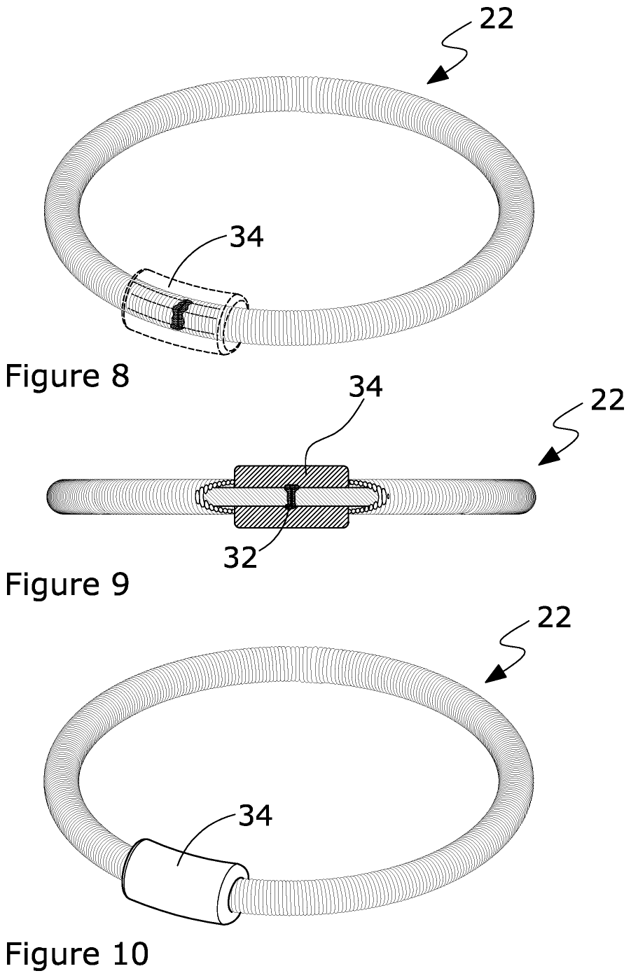

FIG. 10 illustrates an embodiment of a hair fastener 22 according to the present invention. FIGS. 8-9 are schematic views showing an interior structure of a connecting region of the fastener 22. The hair fastener 22 is firstly illustrated by way of its method of manufacture as shown in FIGS. 4 to 7.

FIGS. 4 to 7 illustrate an embodiment of a method of manufacture of a hair fastener 22 according to the present invention. FIG. 4 shows initial steps in which an elongate elastic band 24 is provided. The elastic band 24 has a circumferential length of 65-205 mm and is made of a high elasticity material selected from a group including natural rubber, silicone, TPE, polyester-polyurethane copolymer elastane, and has a rectangular or square cross section. The elastic band 24 has a width or diameter of 0.8-10 mm. The invention can exist in at least two configurations in which in a first configuration the elastic band has a circular cross section, and in that configuration the diameter of the elastic band is from 1.8-8.0 mm. In a different configuration, the elastic band 24 has a cross section of a square shape (or a quadrilateral). In an alternative embodiment, more than one elastic band may be used. Regardless of the cross-sectional profile, the elastic band before assembly has open opposite ends 26, 28.

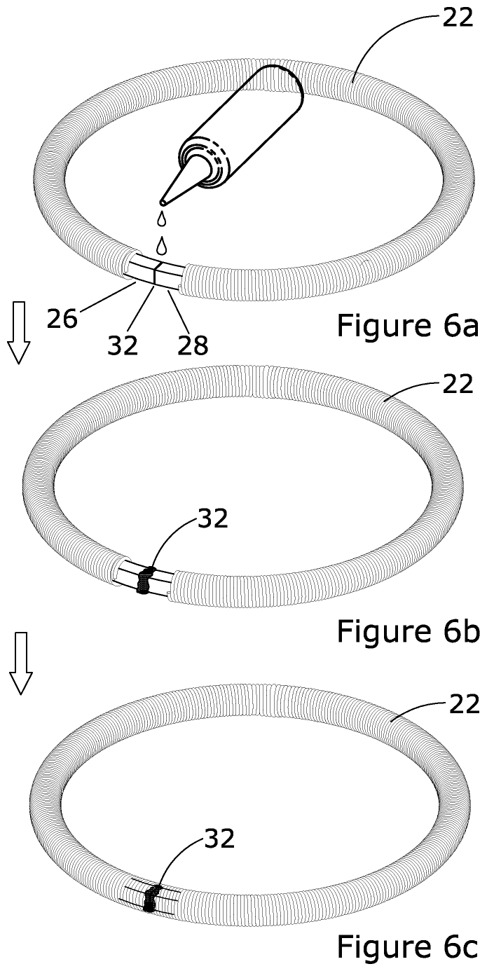

After provision of the elongate elastic band 24, a step is performed by knitting a layer of fabric 30 over a majority length or essentially an entire length of the open-ended elastic band. In this embodiment, the fabric 30 used is made of essentially nylon although studies leading to the present invention identifies that the fabric may be made of polyester, polypropylene or a combination thereof. In the context of the present invention, nylon is one preferred material because fabric formed therefrom possesses appropriate degree of smoothness which is particularly suitable in this application. In this step, the knitting is initially performed with the opposite ends still being un-connected yet. As the knitting is almost being completed such that the majority of the surface of the elastic band is covered, it is cut into the desired sections for subsequently forming closed loops. Regardless of the profile of the elastic band 24, each elastic band section has end surfaces defined by open ends still designated 26, 28 and circumferential surface along an elongate length of the elastic band 24. Please see FIG. 5.

The opposite ends of the sections of the elastic band are then connected together by positioning the opposite ends adjacent each other and joining them by an adhesive. The adhesive itself forms a first coupler 32. In this embodiment, the adhesive used is generally known as or contains a glue in the cyanoacrylate family. It is to be noted that no metallic clip or crimp is used in the connection of the opposite ends 26, 28. This is advantageous because, during studies leading to the present invention upon, it was identified that repeated stretching the use of metal crimps would actually induce breakage at the opposite ends 26, 28. In other words, embodiments of fasteners in accordance with the present invention is advantageous in at least a two-fold manner. First, they can reduce breakage of hair when they are removed or unfastened from hair. Second, in the absence of the metallic clip or crimp breakage at the region of the opposite ends is much reduced. It is also to be appreciated that the use of the adhesive can avoid the use of rigid or metallic component which would substantially increase the width or diameter of region at the first coupler.

When an elastic loop of a desired size is formed by joining opposite ends 26, 28, it is subjected to a step of overmoulding thus forming a second coupler 34 over region of the connected opposite ends 26, 28 at the first coupler 32. The second coupler 34 is formed by injection moulding thermoplastic elastomer. In this embodiment, the second coupler 34 is elongate in shape resembling a bead. By resembling a bead, it refers to the bead having an elongate and round shape with a hole through which the elongate band 24 passes. Specifically, the elongate band 24 and opposite ends of the nylon fabric layer are molded over the second coupler thus connecting the opposite ends of the nylon fabric. The second coupler thus acts as an envelope protecting, encasing and bridging this region and enhance connection of the opposite ends. Specifically, the second coupler 34 additionally provides a secondary connection to the opposite ends of the elongate band 24 and provides connection to and gripping onto the opposite ends of the nylon fabric, in itself, via its molding over, is fixedly connected to the elongate band 24 at the first coupler. The second coupler 34 once secured is irremovable from and not slidable along the first coupler 32. Due to the molding over of the first coupler 32, the second coupler 34 essentially takes the form of a shell fixedly enveloping and around and encasing the first coupler 32 and opposite ends of the nylon fabric jacket. Studies leading to the present invention indicates that the thickness of the shell ranges from 1-4 mm for achieving the intended characteristics of the hair fastener 22. When the opposite ends are jacketed with the shell, the width of the hair fastener at the second coupler 34 is increased from 0.8-10 mm by 1-4 mm, thus the total width of the hair fastener thereat would be up to 14 mm. The length of the second coupler 34 ranges from 0.58-1.72 mm or preferably 0.92-1.38 mm. With these configurations, the following ratio can be summarized.

TABLE 1
Comparison of dimensions of hair fastener

| Comparison | Ratio |
|---|---|
| Width of elastic band to length of hair faster | 0.8-10:65-205 |
| Thickness of shell of second coupler to length of | 1-4:65-205 |
| hair fastener | |
| Length of second coupler to length of hair fastener | 0.58-1.72:65-206 |
| Width of elastic band to thickness of shell of second | 0.8-10:1-4 |
| coupler | |
| Thickness of shell of second coupler to length of | 1-4:0.58-1.72 |
| second coupler | |

These dimensional characteristics provides that the second coupler 34 can provide sufficient connection strength to the opposite ends and protection to the first coupler but do not interfere with tidying or gripping of hair by the hair fastener. Further, it is to be noted that the second coupler 34 is deformable with the elastic band. Thus, when the hair fastener is bent and flex during hair tying, the second coupler 34 flexes along to confirm to the surface of the hair to be tided.

The second coupler 34 is made with a material with higher frictional surface. Due to the higher frictional surface of the second coupler material, it also enhances the fasteners to grip on the hair being tight and thus to increase its gripping capability. In other embodiments, the second coupler may be configured to adopt the configuration of a decorative item.

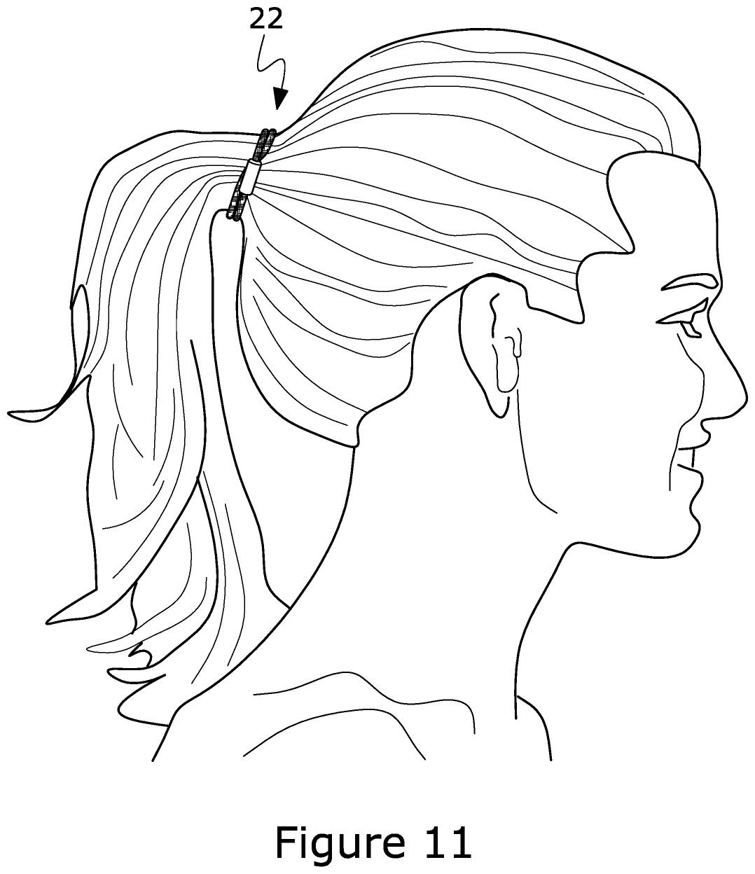

FIG. 11 shows the hair fastener 22 worn on a user.

The hair fastener 22 is also characterised in that while along the length of the fastener both of the elastic band portion and the surrounding fabric portion are elastically and reciprocatingly stretchable, the connection region at which the first coupler and the second coupler resides is also elastically deformable. This is due to the material, structural and configurational characteristics of the elastic band, the surrounding fabric, the first coupler and the second coupler.

Hair fasteners made in accordance with the present invention are advantageous in a number of ways. First, the use of dual connection, i.e. i) adhesion by adhesive of the opposite ends and ii) connection by coupler at the opposite ends over the nylon fabric significantly improve repeated tension of the hair fastener. Studies show that such hair fasteners have a pull strength at the region of the coupler of over 4 Kg, and often >4 Kg to 15 Kg, or even >10 Kg to 15 Kg. Second, the use of the second coupler made of TPE is advantageous because this particular material can provide contact comfort which is not possible when using for example natural rubber. Further, optionally, without the use of metallic crimp or clip in connecting the opposite ends of the elastic band, the drawback of the opposite ends actually torn apart by the crimp or clip is prevented. The possibility of an exposed metallic clip tearing off user's hair in use is also prevented.

It should be understood that certain features of the invention, which are, for clarity, described in the content of separate embodiments, may be provided in combination in a single embodiment. Conversely, various features of the invention which are, for brevity, described in the content of a single embodiment, may be provided separately or in any appropriate sub-combinations. It is to be noted that certain features of the embodiments are illustrated by way of non-limiting examples. Also, a skilled person in the art will be aware of the prior art which is not explained in the above for brevity purpose.

1. A hair fastener with a circumferential length from 65-205 mm, comprising:
a. an elastic band with a width from 0.8-10 mm, defining an outwardly facing surface along a length of said elongate band and with opposite ends defining end surfaces positioned adjacent each other at a connection region thus forming a closed loop;
b. a layer of fabric enveloping along the length of said elastic band and with opposite ends at the connection region;
c. a first coupler for providing a first connection connecting the opposite ends of said elongate band together; and
d. a second coupler resembling a shell molded over and enveloping the first connection thus simultaneously i) providing a second connection to the opposite ends of said elongate band, ii) providing protection of said first coupler by enveloping the first coupler, iii) providing connection to the opposite ends of said fabric layer and iv) enveloping the opposite ends of said fabric layer;
wherein:
said first coupler connects said opposite ends of the elastic band together by joining at the end surfaces at the connection region but without increasing width or diameter of the connection region; and
said second coupler at the connection region is sized and shaped with an enlarged width or diameter compared to the width or diameter of said first coupler at the connection region, wherein the thickness of the shell of said second coupler is from 1-4 mm.

2. A hair fastener as claimed in claim 1, wherein said elastic band has a circular cross section with a diameter from 1.8-8.0 mm.

3. A hair fastener as claimed in claim 1, wherein said elastic band has a quadrilateral cross section.

4. A hair fastener as claimed in claim 1, wherein said elastic band is made from a material selected from the group consisting of natural rubber, silicone thermoplastic elastomer (TPE) and polyester-polyurethane copolymer elastane.

5. A hair fastener as claimed in claim 4, wherein said first coupler is in the form of a glue selected from a cyanoacrylate family.

6. A hair fastener as claimed in claim 5, wherein said fabric is made of nylon, polyester, polypropylene or a combination thereof, and knitted or otherwise formed over said elastic band.

7. A hair fastener as claimed in claim 6, wherein said elastic band with said first and second couplers has a pull strength of at least 4 Kg.

8. A hair fastener as claimed in claim 7, wherein said elastic band with said first and second couplers has a pull strength of 4-15 Kg.

9. A hair fastener as claimed in claim 8, wherein said elastic band at said first and second connectors has a pull strength of 10-15 Kg.

10. A hair fastener as claimed in claim 1, wherein said fastener is free of clip, crimp or clamp for connecting the opposite ends of said elastic band together.

11. A hair fastener as claimed in claim 1, wherein said second coupler is free of silicone rubber, rubber or polyvinyl chloride (PVC).

12. A hair fastener as claimed in claim 1, wherein surface of said coupler is configured with an anti-slipping characteristics for enhancing grip of surrounding hair.

13. A method of manufacture of a hair fastener, comprising steps of:
providing an elongate elastic band with an extended length and with a width from 0.8-10 mm;
forming a jacket made of a fabric along essentially an entire length over the elastic band;
cutting the elastic band covered with the jacket into sections, each section with a desired length from 65-205 mm, thus producing a plurality of fabric-covered elastic band sections with opposite ends;
providing a primary connection by connecting the opposite ends of each elastic band section with a first coupler such that each elastic band section becomes a loop;
optionally completing formation of the fabric jacket over an entire length the loop; and
providing a second coupler fixedly molded over the connected opposite ends and the first coupler, thus simultaneously providing secondary connection to the opposite ends of the elastic band, protecting the primary connection and connecting of opposite ends of the fabric jacket, the second coupler resembling a shell and with a thickness of 1-4 mm;
wherein the first coupler is an adhesive for gluing the opposite ends of each said elastic band section together at end surfaces thereof but without increasing circumferential width or diameter of the elastic band section at the opposite ends.

14. A method as claimed in claim 13, wherein the elastic band is made of natural rubber, silicone, TPE, or polyester-polyurethane copolymer elastane.

15. A method as claimed in claim 14, wherein the jacket is made of a nylon, polyester, polypropylene or a combination thereof, knitted or otherwise formed over said elastic band.

16. A method as claimed in claim 14, wherein the adhesive is selected from a cyanoacrylate family.

17. 16. A method as claimed in claim 12, wherein the second connector is made of thermoplastic elastomer (TPE) and is free of silicon rubber, rubber or polyvinyl chloride (PVC).

18. 17. A method as claimed in claim 12, wherein the elastic band at the first and second connectors has a pull strength of at least 4 Kg, preferably 4-15 Kg, and more preferably 0-15 Kg.
